(19) United States
(12) Patent Application Publication
(10) Pub. No.: US 2004/0024773 A1
(43) Pub. Date: Feb. 5, 2004

(54) Sequence miner

(76) Inventors: Kilian Stoffel, Bevaix (CH); Paul Cotofrei, Neuchatel (CH)

Correspondence Address: Martin G. Linihan, Hodgson Russ LLP, One M&T Plaza, Suite 2000, Buffalo, NY, 14203-2391, US

(21) Appl. No.: 10/425,507

(22) Filed: Apr. 29, 2003

Related U.S. Application Data
(60) Provisional application No. 60/376,310, filed on Apr. 29, 2002.

(51) Int. Cl. G06F 17/00

(52) U.S. Cl. 707/102

(57) ABSTRACT

A computer-based data mining method wherein an event database is extracted from sequential raw data in the form of a multi-dimensional time series and comprehensible temporal rules are extracted using the event database

### CROSS REFERENCE TO A RELATED APPLICATION

Applicants hereby claim priority based on U.S. Provisional Patent Application No. 60/376,310 filed Apr. 29, 2002 entitled “Sequence Miner” which is incorporated herein by reference.

### BACKGROUND OF THE INVENTION

Data mining is the process of discovering interesting knowledge, such as patterns, associations, changes, anomalies and significant structures, from large amounts of data stored in databases, data warehouses, or other information repositories. Due to the wide availability of huge amounts of data in electronic form, and the imminent need for turning such data into useful information and knowledge for broad applications including market analysis, business management, and decision support, data mining has attracted a great deal of attention in the information industry in recent years.

In many applications, the data of interest comprises multiple sequences that evolve over time. Examples include financial market data, currency exchange rates, network traffic data, sensor information from robots, signals from biomedical sources like electrocardiographs, demographic data from multiple jurisdictions, etc. Traditionally time series analysis was a statistical task. Although traditional time series techniques can sometimes produce accurate results, few can provide easily understandable results. However, a drastically increasing number of users with a limited statistical background would like to use these tools. Therefore it becomes more and more important to be able to produce results that can be interpreted by domain experts without special statistical training. At the same time there are a limited amount of tools proposed by researchers in the field of artificial intelligence which produce in principal easier understandable rules. However they have to use ad-hoc, domain-specific techniques for “flattering” the time series to a learner-friendly representation, which fails to take into account both the special problems and special heuristics applicable to temporal data and often results in unreadable concept description.

### SUMMARY OF THE INVENTION

To overcome the foregoing problems, a framework is created that integrates techniques developed both in the field of machine learning and in the field of statistics. The machine learning approaches may be used to extract symbolic knowledge and the statistical approaches may be used to perform numerical analysis of the raw data. The overall goal includes developing a series of fundamental methods capable to extract/generate/describe comprehensible temporal rules. These rules may have the following characteristics:

Contain explicitly a temporal (or at least a sequential) dimension

Capture the correlation between time series

Predict/forecast values/shapes/behavior of sequences (denoted events)

Present a structure readable and comprehensible by human experts

The main steps of the proposed solution to the fundamental problems may be structured in the following way:

Transforming sequential raw data into sequences of events: First, a formal definition of an event is introduced. Roughly speaking, an event can be regarded as a named sequence of points extracted from the raw data and characterized by a finite set of predefined features. The extraction of the points will be based on clustering techniques. Standard clustering methods such as k-means may be employed, but some new methods also will be introduced. The features describing the different events may be extracted using statistical feature extraction processes.

Inferring comprehensible temporal rules: In the second phase a knowledge base may be inferred having comprehensible temporal rules from the event database created during the first phase. This inference process may include several steps. In a first step it is proposed to use a decision tree approach to induce a hierarchical classification structure. From this structure a first set of rules may be extracted. These rules are then filtered and transformed to obtain comprehensible rules which may be used feed a knowledge representation system that will finally answer the users' questions. Existing methods such as decision tree and rule induction algorithms as well as knowledge engineering techniques will be adopted to be able to handle rules, respectively knowledge, representing temporal information.

The following detailed description of the invention, when read in conjunction with the accompanying drawing, is in such full, clear, concise and exact terms as to enable any person skilled in the art to which it pertains, or with which it is most nearly connected, to make and use the invention. The advantages and characterizing features of the present invention will become clearly apparent upon a reading of the following detailed description together with the accompanying drawing.

### BRIEF DESCRIPTION OF THE DRAWINGS

FIG. 1 is a block process diagram illustrating the method of the invention including the processes of obtaining sequential raw data (12), extracting an event database from the sequential raw data (14) and extracting comprehensible temporal rules using the event database (16).

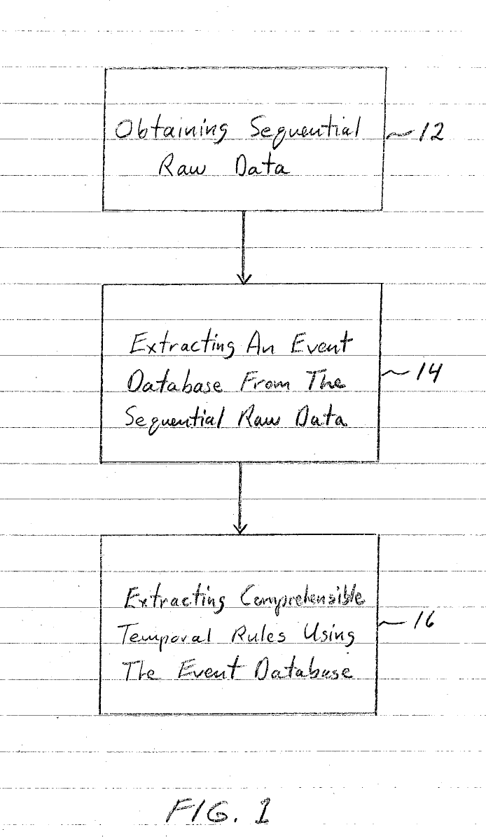

FIG. 2 is a block process diagram further illustrating process (14) of FIG. 1 including using time series discretisation to describe discrete aspects of sequential raw data (20) and using global feature calculation to describe continuous aspects of sequential raw data (22).

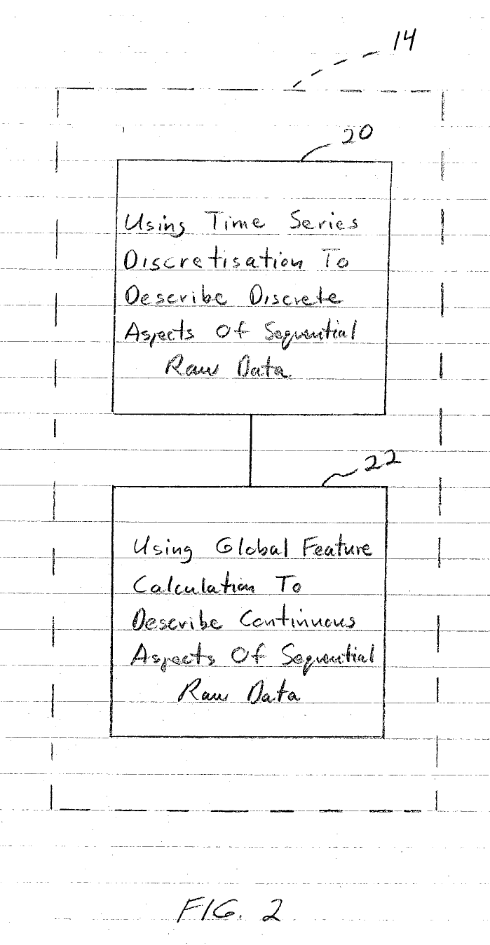

FIG. 3 is a block process diagram further illustrating process (16) of FIG. 1 including applying a first inference process using the event database to obtain a classification tree (30) and applying a second inference process using the classification tree and the event database to obtain a set of temporal rules from which the comprehensible rules are extracted (32).

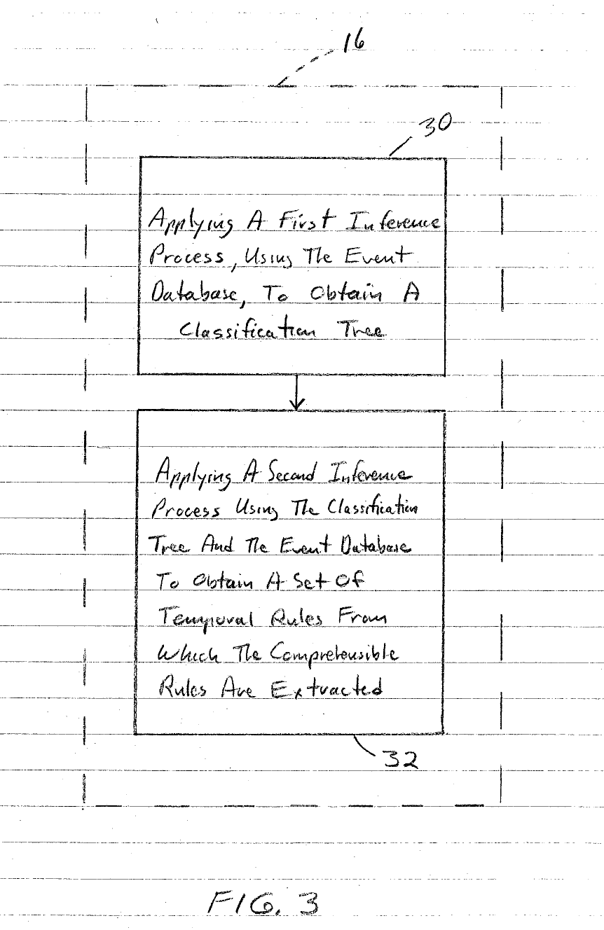

FIG. 4 is a block process diagram further illustrating process (30) of FIG. 3 including specifying criteria for predictive accuracy (40), selecting splits (42), determining when to stop splitting (44) and selecting the right-sized tree (46).

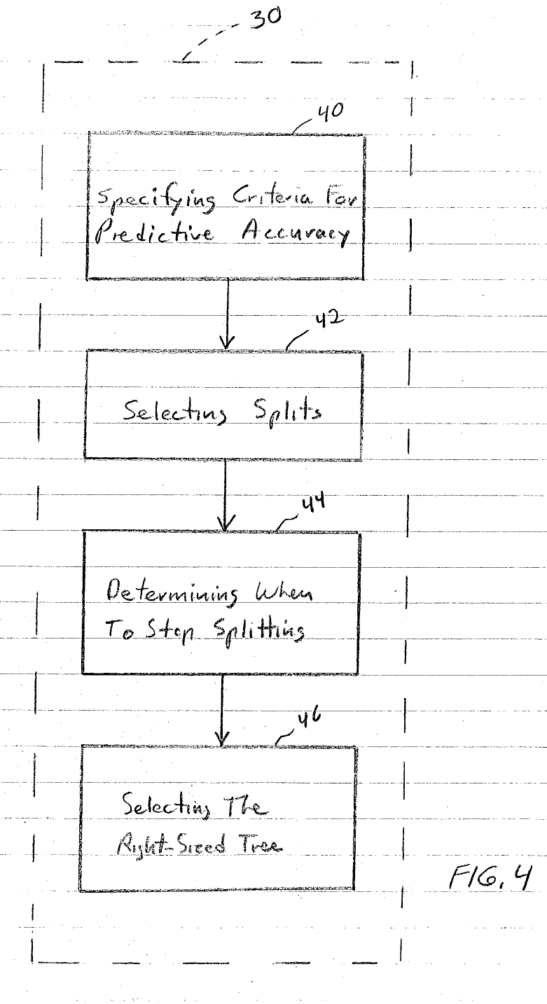

### DETAILED DESCRIPTION OF THE INVENTION

Along with the following Detailed Description, there is included Appendix A and Appendix B. Major ideas, propositions and problems are described in the Detailed Description. In Appendix A and Appendix B, some ideas and remarks from the Detailed Description are further explained, some theoretical aspects receive a solution for a practical implementation and some multiple choices and directions, left open in the Detailed Description, take a more concrete form. In summary:

1. In the Detailed Description at subsection 2.2.3.1 titled “Vocabulary and formal definitions”, there is a short description of a theoretical frame, followed by some general definitions. This theoretical frame is developed in Appendix B, in the section titled “The Formalism of Temporal Rules”, where a formalism based on temporal first logic-order and a set of definitions is proposed.

2. In the Detailed Description there is a section titled “Phase One”. This part is subsequently divided into two steps. First, a section titled “time series discretisation” discusses capture of discrete aspects of data, which is a description of some possible methods of discretisation. Second, a section titled “global feature calculation” discusses capture of continuous aspects of data. In Appendix A, there is a subsection 2.1 titled “The Phase One”, which describes, for the first step, a method of discretisation.

3. In the Detailed Description there is a section titled “Phase Two”. This part is subsequently divided into two steps. First, a section titled “classification trees” discusses the main characteristics of the classification trees constructing process, with a particular interest on the C4.5 algorithm. Also in the section titled “classification trees” is a discussion of an important problem (establishing the training set), and two strategies for addressing this problem are proposed. Second, a section titled “second inference process” discusses the notion of “comprehensibility” for temporal rules and enumerates some metrics that may be used to measure this characteristic.

In Appendix A, the subsection 2.3 and in Appendix B, the subsection 3.2, both named “The Phase Two”, repeats the description of classification trees. On the other hand, the problem of establishing the training set is described, in these two documents, in a distinct section, “Implementation Problems”. In this section a specific procedure to obtain a training set, based on three parameters, is proposed and it is explained how the problem of identifying the dependent variable may be solved. Also, a practical solution for the “insertion” of temporal dimension in the rules extracted from the classification trees (which, by definition, do not have such a dimension) is described. The difference in the approaches described in this section, between Appendix A and Appendix B is that, in Appendix B, the parameters and the mechanism of the procedure are also explained in the context of a proposed formalism.

Because Appendix A is oriented toward a practical application of the methodology, it contains also a section “Experimental Results”, describing the results of applying the proposed practical solutions (the method for time series discretisation and the procedure for obtaining the training sets) to a synthetic database.

1 Summary of the Research Plan

Data mining is the process of discovering interesting knowledge, such as patterns, associations, changes, anomalies and significant structures, from large amounts of data stored in databases, data warehouses, or other information repositories. Due to the wide availability of huge amounts of data in electronic form, and the imminent need for turning such data into useful information and knowledge for broad applications including market analysis, business management, and decision support, data mining has attracted a great deal of attention in the information industry in recent years.

In many applications, the data of interest comprises multiple sequences that evolve over time. Examples include financial market data, currency exchange rates, network traffic data, sensor information from robots, signals from biomedical sources like electrocardiographs, demographic data from multiple jurisdictions, etc. Traditionally time series analysis was a statistical task. Although traditional time series techniques can sometimes produce accurate results, few can provide easily understandable results. However, a drastically increasing number of users with a limited statistical background would like to use these tools. Therefore it becomes more and more important to be able to produce results that can be interpreted by domain experts without special statistical training. At the same time we have a limited amount of tools proposed by researchers in the field of artificial intelligence which produce in principal easier understandable rules. However they have to use ad-hoc, domain-specific techniques for “flattering” the time series to a leaner-friendly representation, which fails to take into account both the special problems and special heuristics applicable to temporal data and often results in unreadable concept description.

To overcome these problems we propose to create a framework that integrates techniques developed both in the field of machine learning and in the field of statistics. The machine learning approaches may be used to extract symbolic knowledge and the statistical approaches may be used to perform numerical analysis of the raw data. The overall goal includes developing a series of fundamental methods capable to extract/generate/describe comprehensible temporal rules. These rules may have the following characteristics:

Contain explicitly a temporal (or at least a sequential) dimension

Capture the correlation between time series

Predict/forecast values/shapes/behavior of sequences (denoted events)

Present a structure readable and comprehensible by human experts

The main steps of the proposed project (and the fundamental problems we proposed to solve) may be structured in the following way:

Transforming sequential raw data into sequences of events: First we will introduce a formal definition of an event. Roughly speaking, an event can be regarded as a named sequence of points extracted from the raw data and characterized by a finite set of predefined features. The extraction of the points will be based on clustering techniques. We will rely on standard clustering methods such as k-means, but also introduce some new methods. The features describing the different events may be extracted using statistical feature extraction processes.

Inferring comprehensible temporal rules: In the second phase we may infer a knowledge base having comprehensible temporal rules from the event database created during the first phase. This inference process may include several steps. In a first step we will propose to use a decision tree approach to induce a hierarchical classification structure. From this structure a first set of rules may be extracted. These rules are then filtered and transformed to obtain comprehensible rules which may be used feed a knowledge representation system that will finally answer the users' questions. We plan to adapt existing methods such as decision tree and rule induction algorithms as well as knowledge engineering techniques to be able to handle rules, respectively knowledge, representing temporal information.

Keywords: data mining, time series analysis, temporal rules, similarity measure, clustering algorithms, classification trees

2 Research Plan

Data Mining is defined as an analytic process designed to explore large amounts of (typically business or market related) data, in search for consistent patterns and/or systematic relationships between variables, and then to validate the findings by applying the detected patterns to new subsets of data. The process thus may include three basic stages: exploration, model building or pattern definition, and validation/verification. Generally, the goal of Data Mining is prediction and description. Prediction relates to inferring unknown or future values of the attributes of interest using other attributes in the databases; while description relates to finding patterns to describe the data in a manner understandable to humans. These two goals can be further classified into the following data mining tasks: classification, regression, clustering, summarization, discrimination, dependency modeling, prediction as well as change and deviation detection. Classification means classifying a data item into one of several predefined classes. Regression means mapping a data item to a real-valued prediction variable. Clustering means identifying a finite set of categories or clusters to describe the data. Summarization means finding a concise description for a subset of data. Discrimination means discovering the features or properties that distinguish one set of data (called target class) from other sets of data (called contrasting classes). Dependency Modeling means finding a model, which describes significant dependencies between variables. Change and Deviation Detection involves discovering the significant changes in the data from previously measured or normative values.

In many applications, the data of interest comprise multiple sequences that evolve over time. Examples include financial markets, network traffic data, sensor information from robots, signals from biomedical sources like electrocardiographs and more. For this reason, in the last years, there has been increased interest in classification, clustering, searching and other processing of information that varies over time.

2.1 State of the Art in the Area of the Project

The main tasks on which the researchers concentrated their efforts may be divided into four directions:

Similarity/Pattern Querying. The main problem addressed by this body of research concerns the measure of similarity between two sequences, sub-sequences respectively. Different models of similarity were proposed, based on different similarity measures. The Euclidean metric and an indexing method based on Discrete Fourier Transformation were used for matching full sequences [AFS93] as well as for sub-pattern matching [FRM94]. This technique has been extended to allow shift and scaling in the time series[GK95]. To overcome the sensibility of the Euclidean metric to outliers, other measures, e.g. the envelope (|Xi—Yi|<ε), were proposed. Different methods (e.g. window stitching) were developed to allow matching similar series despite gaps, translation and scaling [ALSS95, DGM97, FJMM97]. Dynamic time warping based matching is another popular technique in the context of speech processing [SC78], sequence comparison [ES83], shape matching [M91] and time series data pattern matching [BC94]. Efficient indexing techniques for time sequences using this metric were developed [YJF98]. For all similarity search methods, there is a heavy reliance on the user-specified tolerance ε. The quality of the results and the performance of the algorithms are intrinsically tied to this subjective parameter, which is a real usability issue.

Clustering/Classification. In this direction researchers mainly concentrate on optimal algorithms for clustering/classifying sub-sequences of time series into groups/classes of similar sub-sequences. A first technique for temporal classification is the Hidden Markov Model [RJ86]. It turned out to be very useful in speech recognition (it is the basis of a lot of commercial systems). Another recent development for temporal classification tasks are Dynamic Bayes Networks (DBNs) [ZR98, FMR98], which improve HMMs by allowing a more complex representation of the state space. A technique that has gained some use is Recurrent Neural Networks [B96]. This method utilizes a normal feed-forward neural network, but introduces a “context layer” that is fed back to the hidden layer one timestep later and this allows for retention of some state information. Some work has also been completed on signals with high-level event sequence description where the temporal information is represented as a set of timestamped events with parameters. Applications for this method can be found in network traffic analysis systems [MTV95] or network failure analysis systems [OJC98]. Recently machine learning approach opened new directions. A system for supervised classification on univariate signals using piecewise polynomial modeling was developed in [M97] and a technique for agglomerative clustering of univariate time series based on enhancing the time series with a line segment representation was studied in [KP98].

Pattern finding/Prediction. These methods, concerning the search for periodicity patterns in time series databases may be divided into two groups: those that search full periodic patterns (where every point in time contributes, precisely or approximately, to the cyclic behavior of the time series) and those that search partial periodic patterns, which specify the behavior at some but not all points in time. For full periodicity search there is a rich collection of statistic methods, like FFT [LM93]. For partial periodicity search, different algorithms were developed, which explore properties, related to partial periodicity such as the a-priori property and the max-subpattern-hit-set property [HGY98]. New concepts of partial periodicity were introduced, like segment-wise or point-wise periodicity and methods for mining these kind of patterns were developed [HDY99].

Rule extraction. Besides these, some research was devoted to the extraction of explicit rules from time series. Inter-transaction association rules, proposed by Lu [LHF98] are implication rules whose two sides are totally ordered episodes with time-interval restriction on the events. In [BWJ98] a generalization of these rules is developed, having episodes with independent time-interval restrictions on the left-hand and right-hand side. Cyclic association rules were considered in [ORS98], adaptive methods for finding rules whose conditions refer to patterns in time series were described in [DLM98] and a general architecture for classification and extraction of comprehensible rules (or descriptions) was proposed in [W99].

The approaches proposed above have mainly two shortcomings, which we would like to overcome in this project.

The first problem involves the type of knowledge inferred by the systems, which is very difficult to be understood by a human user. In a wide range of applications (e.g. almost all decision making processes) it is unacceptable to produce rules that are not understandable for a user. Therefore we decided to develop inference methods that will produce knowledge that can be represented in general Horn clauses which are at least comprehensible for a moderately sophisticated user. In the fourth approach described above, a similar representation is used. However, the rules inferred by these systems are a more restricted form than the rules we are proposing.

The second problem of the approaches described above involves the number of time series that are considered during the inference process. They are all based on uni-dimensional data, i.e. they are restricted to one time series at the time. However we think this is not sufficient in order to produce knowledge useable for decision making. Therefore the methods we would like to develop during this project would be able to handle multi-dimensional data.

Our goal could be summarized: to extract events from a multi-dimensional time series and to discover comprehensible temporal rules all based on a formal model.

2.2 Research by the Applicant

The project described here is a new one. Our previous research primarily focused on two aspects of data mining. On one hand we were analyzing how data mining algorithms can benefit from knowledge representation systems, and on the other hand how the efficiency of existing systems can be improved.

Contributions in this work include the formalization and the implementation of a knowledge representation language that was scalable enough to be used in conjunction with data mining tools ([SH99], [STH97]). We designed and realized a system that can be used on PCs over WSs up to high-end parallel computer systems (T3D, SP/2, Paragon). The system we built has a relational database system that offers a wide variety of indexing schemes ranging from standard methods such as b-trees and r-trees up to highly specialized methods such as semantic indices. On top of the data base system we built a sophisticated query language that allows for the expression of rules for typical knowledge representation purposes, as well as aggregation queries for descriptive statistics. The main challenge was to offer enough expressively for the knowledge representation part of the system without slowing down the simpler relational queries. The result was a system that was very efficient, sometimes it was even orders of magnitude faster than comparable Al systems. These characteristics made the system well suited for a fairly wide range of KDD applications. The principal data mining tasks performed by the system [THS98, TSH97] were: high level classification rule induction, indexing and grouping.

The system was successfully used in medical information systems [SDS98, SSH97]. The system was patented in 1998 (Parka-DB) and won the “Invention of the year” (1997) award of the Office of Technology Liaison (University of Maryland, MD, USA).

We have two other projects closely related to the proposed project. The first one analyzes the possibility of implementing efficient clustering algorithms for very large data sets. More precisely we adapted standard clustering algorithms in order to be able to handle large amounts of data on simple networks of PCs. First results were published in [SB99]. These results are important for the proposed project because these clustering techniques are an essential part of this proposal.

The second one is a project founded by the SNF (2100-056986.99). The main interest in this project is to gain fundamental insight in the construction of decision trees in order to improve their applicability to larger data sets. This is of great interest in the field of data mining. First results in this project are described in the paper [SR00]. These results are also of importance to this proposal as we are envisaging to use decision trees as the essential induction tool in this project.

2.3 Detailed Research Plan

We propose development of a series of methods capable to extract comprehensible temporal rules with the following characteristics:

Allowing an explicit temporal dimension: i.e. The body of the rule has a variable T permitting the ordering of events over time. The values of T may be absolute or relative (i.e. we can use an absolute or a relative origin). Furthermore, a generalization of the variable T may be considered, which treats each instance of T as a discrete random variable (permitting an interpretation: “An event E occurs at time ti where ti lays in the interval [t1, t2] with probability pi”)

Capturing the correlation between time series: The events used in rules may be extracted from different time series (or streams) which may be considered to being moderately (or strongly) correlated. The influence of this correlation on the performance and comportment of the classification algorithms, which were created to work with statistically independent database records, will have to be investigated.

Predict/forecast values/shapes/behavior of sequences: The set of rules, constructed using the available information may be capable of predicting possible future events (values, shapes or behaviors). In this sense, we may establish a pertinent measure for the goodness of prediction.

Present a structure readable and comprehensible by human experts:The structure of the rule may be simple enough to permit to users, experts in their domain but with a less marked mathematical background (medicines, biologists, psychologists, etc . . . ), to understand the knowledge extracted and presented in form of rules.

In the following sections we will describe how we plan to achieve our goals. After a short introduction of the basic vocabulary and definitions, we will describe each milestone of this project in some more details.

2.3.1 Vocabulary and Formal Definitions

For a cleaner description of the proposed approach, we introduce in detail the notations and the definitions used in this proposal.

A first-order alphabet includes variables, predicate symbols and function symbols (which include constants). An upper case letter followed by a string of lower case letters and/or digits represents a variable. There is a special variable, T, representing time. A function symbol is a lower case letter followed by a string of lower case letters and/or digits. A predicate symbol is a lower case letter followed by a string of lower case letters and/or digits.

A term is either a variable or a function symbol immediately followed by a bracketed n-tuple of terms. Thus ƒ(g(X),h) is a term where ƒ, g and h are functions symbols and X is a variable. A constant is a function symbol of arity 0, i.e. followed by a bracketed 0-tuple of terms. A predicate symbol immediately followed by a bracketed n-tuple of terms is called an atomic formula, or atom. Both B and its negation [symbol] B are literals whenever B is an atomic formula. In this case B is called a positive literal and [symbol] B is called a negative literal.

A clause is a formula of the form ∀X₁∀X₂ . . . ∀Xₛ(B₁ [symbol] B₂ [symbol] . . . [symbol] Bₘ) where each Bᵢ is a literal and X₁, . . . , Xₛ are all the variables occurring in B₁ [symbol] B₂ [symbol] . . . , [symbol] Bₘ. A clause can also be represented as a finite set (possibly empty) of literals. Thus the set [B₁,B₂, . . . , [symbol] Bᵢ, [symbol] Bᵢ₊₁, . . . ] stands for the clause B₁ [symbol] B₂ [symbol] . . . [symbol] [symbol] Bᵢ [symbol] [symbol] B_{i +1}, . . . which is equivalently represented as B₁ [symbol] B₂ [symbol] . . . ←BᵢΛBᵢ₊₁, . . . . If E is a literal or a clause and if vars(E)=Ø (where vars(E) denote the set of variables in E), than E is said to be ground.

DEFINITION 1. An event is an atom composed by the predicate symbol E followed by a bracketed n-tuple of terms (n>=2). The first term of the n-tuple is a constant representing the name of the event and there is at least a term containing a continuous variable.

DEFINITION 2 A temporal atom (or temporal literal) is a bracketed 2-tuple, where the first term is an event and the second is a time variable, Tᵢ.

DEFINITION 3 A temporal rule is a clause, which contains exactly one positive temporal literal. It has the form H←B₁ΛB₂Λ . . . ΛBₙ where H, Bᵢ are temporal atoms.

2.3.2 Description of the Main Steps and Problems

Using the definitions given in the previous section we are introducing in the following in chronological order the most important steps of the proposed project. We start from a database of sequential “raw” data and we would like to finish the whole process with a knowledge base of comprehensible temporal rules. The overall process can be divided into two major phases:

1. starting from sequential raw data we will extract an event database (according to the definition given above) and

2. the event database will be used to extract comprehensible temporal rules

Phase One

First we may introduce a language allowing the description of events. The two scientific communities which made important contributions relevant to this project (the statisticians and database researchers) choose two different approaches: statisticians concentrate on the continuous aspect of the data and the large majority of statistical models are continuous models, whereas the database community concentrates much more on the discrete aspect, and in consequence, on discrete models. The point of view we are adopting here is that a mixture of these two approaches would represent a better description of the reality of data and would in general allow us to benefit of the advantages of both approaches. However the techniques applied by the two communities would have to be adapted in order to be able to handle both types of models.

As an example, the discrete approach starts always from a finite set of predefined discrete events. One can imagine that the real values are described by an interval, e.g. the values between 0 and 5 are substituted by “small” and the values between 5 and 10 by “big”. The same way we can describe the changes between two consecutive points in a time series by “stable”, “increase” and “decrease”. Events are now described by a list composed of elements using this alphabet. E.g. E=(“big” “decrease” “decrease” “big”) represents an event describing a sequence that starts from a big value, decreases twice and stops still at a big value. However expressions like “an increase of 15%” can not be expressed in this formalism as the exact values of a given point in the time series are no longer known. The later expression, however, can easily be handled in a continuous model. The problem with the continuous model is that it can not really be used to express descriptive rules, because of the infinity of possible values found in the raw data.

We will now introduce the procedure we are proposing for the extraction of events that will include discrete as well as continuous aspects from the raw data. This procedure can be divided into two steps: time series discretisation, which describes the discrete aspect, and global feature calculation, which describes the continuous aspect.

Time series discretisation. As a first approach for the discretisation of times series we will evaluate the so called window's clustering method [DLM98]. It can be described in the following way: Given a sequence, s=(xᵢ, . . . , xₙ) and parameter w, a window of width w on s can be defined as a contiguous subsequence (xᵢ, . . . , x_{i+w-1}). We form from s all windows (subsequences) sᵢ, . . . , s_{n-w+1} of width w, where sᵢ=(xᵢ, . . . , x_{i+w-1}), and denote the set [sᵢ|i=1, . . . n−w+1] by W(s). Assuming we have a distance d(sᵢ,sⱼ) between any two subsequences sᵢ and sⱼ of width w, this distance can be used to cluster the set of all subsequences of W(s) into clusters Cₗ, . . . , Cₖ. For each cluster Cₕ we introduce a symbol aₕ and the discretised version D(s) of the sequence s will be expressed using the alphabet Σ=[aᵢ, . . . , aₖ]. The sequence D(s) is obtained by finding for each subsequence sᵢ the corresponding cluster Cⱼ₍ᵢ₎ such that sᵢεCⱼ₍ᵢ₎ and using the corresponding symbol aⱼ₍ᵢ₎. Thus D(s)=aⱼ₍₁₎, aⱼ₍₂₎, . . . , a_{j(n-w+1)}.

This discretisation process depends on the choice of w, on the time series distance function and on the type of clustering algorithm. In respect to the width of the window, we may notice that a small w may produce rules that describe short-term trends, while a large w may produce rules that give a more global view of the data set.

To cluster the set W(s) we need a distance function for time series of length w. There are several possibilities. The simplest possibility is to treat the sub-sequences of length w as elements of R^{w} and to use the Euclidean distance (i.e. the L₂ metric). That is, for \overline{x}=(xᵢ, . . . , x_{w}) and \overline{y}=(yᵢ, . . . , y_{w}), the distances d(\overline{x}, \overline{y}) is in fact (Σᵢ(ₓᵢ−yᵢ)²)^{1/2}. However, for many applications, the shape of the sub-sequence is seen as the main factor in distance determination. Thus, two sub-sequences may have essentially the same shape, although they may differ in their amplitudes and baseline. One way to measure the distance between the shape of two series is by normalizing the sub-sequences and then using the L₂ metric on the normalized sub-sequences. Denoting the normalized version of sequence \overline{x} by η(\overline{x}), we define the distance between \overline{x} and \overline{y} by d(\overline{x}, \overline{y})=L₂(η(\overline{x}),η(\overline{y})). As possible normalization, we may use η(\overline{x})ᵢ=xᵢ−E(\overline{x}) or η(\overline{x})ᵢ=(xᵢ−E(\overline{x}))/D(\overline{x}) where E(\overline{x}) is the mean of the values of the sequence and D(\overline{x}) is the standard deviation of the sequence. The distance between normalized sequences will be our first choice for this project. Certain articles describe other more sophisticated time series distance measures which may be considered as alternatives in the case that the first choice turns out to be insufficient. As an example, the dynamic time warping method involves the use of dynamic programming techniques to solve an elastic pattern-matching task [BC94]. In this technique, to temporally align two sequences, r[t], 0<t<T , and r′[t], 0<t<T′, we consider the grid whose horizontal axis is associated with r and whose vertical axis is associated with r′. Each element of a grid contains the distance between r[i] and r′[j]. The best time warp will minimize the accumulated distance along a monotonic path through the grid from (0; 0) to (T; T′). Another alternative is a probabilistic distance model based on the notion of an ideal prototype template, which can be “deformed” according to a prior probability distribution to generate the observed data [KS97]. The model comprises local features (peaks, plateau, etc.) which are then composed into a global shape sequence. The local features are allowed to some degree of deformation and the global shape sequence has a degree of elasticity allowing stretching in time as well as stretching of the amplitude of the signal. The degree of deformation and elasticity are governed by prior probability distribution.

After the distance between sequences has been established, any clustering algorithms can be used, in principle, to cluster the sub-sequences in W(s). We will test two methods. The first method is a greedy method for producing clusters with at most a given diameter. Each sub-sequence in W(s) represents a point in R^{w}, L₂ is the metric used as distance between these points and d>0 (half of maximal distance between two points in the same cluster) is the parameter of the algorithm. For each point p in W(s), the method finds the cluster center q such that d(p,q) is minimal. If d(p,q)<d than p is added to the cluster with center q, otherwise a new cluster with center p is formed. The second method is the traditional k-means algorithm, where cluster centers for k clusters are initially chosen at random among the points of W(s). In each iteration, each sub-sequence of W(s) is assigned to the cluster whose center is nearest to it. Then, for each cluster its center is recalculated as the pointwise average of the sequences contained in the cluster. All these steps are repeated until the process converges. A theoretical disadvantage is that the number of clusters has to be known in advance: too many clusters means too many kinds of events and so less comprehensible rules; too few clusters means that clusters contain sequences that are too far apart, and so the same event will represent very different trends (again less comprehensible rules finally). It is important to notice that this method infers an alphabet (types of events) from the data, that is not provided by a domain expert but is influenced by the parameters of the clustering algorithm.

Global feature calculation. During this step one extracts various features from each subsequence as a whole. Typical global features include global maxima, global minima, means and standard deviation of the values of the sequence as well as the value of some specific point of the sequence such as the value of the first and of the last point. Of course, it is possible that specific events may demand specific features important for their description (e.g. the average value of the gradient for an event representing an increasing behavior). The optimal set of global features is hard to define in advance, but as most of these features are simple descriptive statistics, they can easily be added or removed from the process. However, there is a special feature that will be present for each sequence, namely the time. The value of the time feature will be equal to the point in time when the event started.

The first phase can be summarized as: the establishing of the best method of discretisation (for the method described here, this means the establishing of the window's width w, the choice of the distance d and of the parameters of the clustering algorithm). There are also other methods which we might have to explore if the results obtained using this first method are not encouraging, like the direct use of Fourier coefficients [FRM94] or parametric spectral models [S94], for sequences which are locally stationary in time, or piecewise linear segmentation [KS97], for sequences containing transient behavior. The last approach may be specially interesting, because it captures the hierarchy of events in a relational tree, from the most simple (linear segments) to more complicated, and it allows to overpass the difficulty of a fixed event length. In regard to the clustering algorithms, we think that for our project the k-means algorithm presents the advantage (which contrasts the common critics) of controlling the number of possible events. There is considerable psychological evidence that a human comprehensible rule must contain a limited number of types of events and a limited number of conjunctions of events. So, the possibility to control the parameter k is crucial (although we will not fix this parameter in advance to preserve enough flexibility, we will restrain it to a predefined interval.)

Phase Two

During the second phase we may create a set of comprehensible temporal rules inferred from the events database. This database was created using the procedures described above. Two important steps can be defined here:

1. application of a first inference process, using the event database as training database, to obtain a classification tree and

2. application of a second inference process using the previously inferred classification tree as well as the event database to obtain a second set of temporal rules from which the comprehensible rules will be extracted.

Classification trees. There are different approaches for extracting rules from a set of events. Associations Rules, Inductive Logic Programming, Classification Trees are the most popular ones. For our project we selected the classification tree approach. It represents a powerful tool, used to predict memberships of cases or objects in the classes of a categorical dependent variable from their measurements on one or more predictor variables. A classification tree is constructed by recursively partitioning a learning sample of data in which the class label and the value of the predictor variables for each case are known. Each partition is represented by a node in the tree. The classification trees readily lend themselves to being displayed graphically, helping to make them easier to interpret than they would be if only a strict numerical interpretation were possible. The most important characteristics of a classification tree are the hierarchical nature and the flexibility. The hierarchical nature of the classification tree refers to the relationship of a leaf to the tree on which it grows and can be described by the hierarchy of splits of branches (starting from the root) leading to the last branch from which the leaf hangs. This contrasts the simultaneous nature of other classification tools, like discriminant analysis. The second characteristic reflects the ability of classification trees to examine the effects of the predictor variables one at a time, rather than just all at once. A variety of classification tree programs has been developed and we may mention QUEST ([LS97], CART [BFO84], FACT [LV88],THAID [MM73], CHAID, [K80] and last, but not least, C4.5 [Q93]. For our project, we will select as a first option a C4.5 like approach. In the remainder of this section we will present the applicability of the decision tree approach to the domain of sequential data. The process of constructing decision trees can be divided into the following four steps:

Specifying the criteria for predictive accuracy,

Selecting splits,

Determining when to stop splitting, and

Choosing the “right-sized” tree.

Specifying the criteria for predictive accuracy. A goal of classification tree analysis, simply stated, is to obtain the most accurate prediction possible. To solve the problem of defining predictive accuracy, the problem is “stood on its head,” and the most accurate prediction is operationally defined as the prediction with the minimum costs. The notion of costs was developed as a way to generalize, to a broader range of prediction situations, the idea that the best prediction has the lowest misclassification rate. Priors, or, a priori probabilities, specify how likely it is, without using any prior knowledge of the values for the predictor variables in the model, that a case or object will fall into one of the classes. In most cases, minimizing costs correspond to minimizing the proportion of misclassified cases when priors are taken to be proportional to the class sizes and when misclassification costs are taken to be equal for every class. The tree resulting by applying the C4.5 algorithm is constructed to minimize the observed error rate, using equal priors. For our project, this criteria seems to be satisfactory and furthermore has the advantage to not advantage certain events.

Selecting splits. The second basic step in classification tree construction is to select the splits on the predictor variables that are used to predict membership of the classes of the dependent variables for the cases or objects in the analysis. These splits are selected one at the time, starting with the split at the root node, and continuing with splits of resulting child nodes until splitting stops, and the child nodes which have not been split become terminal nodes. The three most popular split selection methods are:

Discriminant-based univariate splits [LS97]. The first step is to determine the best terminal node to split in the current tree, and which predictor variable to use to perform the split. For each terminal node, p-values are computed for tests of the significance of the relationship of class membership with the levels of each predictor variable. The tests used most often are the Chi-square test of independence, for categorical predictors, and the ANOVA F-test for ordered predictors. The predictor variable with the minimum p-value is selected.

The second step consists in applying the 2-means clustering algorithm of Hartigan and Wong to create two “superclasses” for the classes presented in the node. For ordered predictor, the two roots for a quadratic equation describing the difference in the means of the “superclasses” are found and used to compute the value for the split. For categorical predictors, dummy-coded variables representing the levels of the categorical predictor are constructed, and then singular value decomposition methods are applied to transform the dummmy-coded variables into a set of non-redundant ordered predictors. Then the procedures for ordered predictor are applied. This approach is well suited for our data (events and global features) as it is able to treat continuous and discrete attributes in the same tree.

Discriminant-based linear combination splits. This method works by treating the continuous predictors from which linear combinations are formed in a manner that is similar to the way categorical predictors are treated in the previous method. Singular value decomposition methods are used to transform the continuous predictors into a new set of non-redundant predictors. The procedures for creating “superclasses” and finding the split closest to a “superclass” mean are then applied, and the results are “mapped back” onto the original continuous predictors and represented as a univariate split on a linear combination of predictor variables. This approach, inheriting the advantages of the first splitting method, uses a larger set of possible splits thus reducing the error rate of the tree, but, at the same time, increases the computational costs.

CART-style exhaustive search for univariate splits. With this method, all possible splits for each predictor variable at each node are examined to find the split producing the largest improvement in goodness of fit (or equivalently, the largest reduction in lack of fit). There exist different ways of measuring goodness of fit. The Gini measure of node impurity [BFO84] is a measure which reaches a value of zero when only one class is present at a node and it is used in CART algorithm. Other two indices are the Chi-square measure, which is similar to Bartlett's Chi-square and the G-square measure, which is similar to the maximum-likelihood Chi-square. Adopting the same approach, the C4.5 algorithm uses the gain criterion as goodness of fit. If S is any set of cases, let freq(Cᵢ, S) stands for the number of cases in S that belong to class Cᵢ. The entropy of the set S (or the average amount of information needed to identify the class of a case in S) is the sum:

$$info ( S ) = - {\sum }_{j} \frac{freq ( {C}_{j} , S )}{\vert S \vert} \times {log}_{2} ( \frac{freq ( {C}_{j} , S )}{\vert S \vert} ) .$$

After S is partitioned in accordance with n outcomes of a test X, a similar measure is the sum:

$${info }_{x} ( S ) = {{\sum }_{i = 1}}^{n} \frac{\vert {S}_{i} \vert}{\vert S \vert} \times info ( {S}_{i} ) .$$

The quantity gain(X)=info(S)−infoₓ(S) measures the information that is gained by partitioning S in accordance with test X. The gain criterion selects a test to maximize this information gain. The bias inherent in the gain criterion can be rectified by a kind of normalization in which the apparent gain attributable to the test with many outcomes is adjusted. By analogy with the definition of info(S), on define

$$split info ( X ) = - {\sum }_{i} \frac{\vert {S}_{i} \vert}{\vert S \vert} \times {log}_{i} ( \frac{\vert {S}_{i} \vert}{\vert S \vert} ) ,$$

representing the potential information generated by dividing S into n subsets. Then, the quantity gain ratio(X)=gain(X)/split info(X) express the proportion of information generated by the split that is useful. The gain ratio criterion selects a test to maximize the ratio above, subject to the constraint that the information gain must be large—at least as great as the average gain over all tests examined. The C4.5 algorithm uses three forms of tests: the “standard” test on a discrete attribute, with one outcome and branch for each possible value of the attribute, a more complex test, based on a discrete attribute, in which the possible values are allocated to a variable number of groups with one outcome for each group and a binary test, for continuous attributes, with outcomes A≦Z and A>Z , where A is the attribute and Z is a threshold value.

Remark 1: For our project, the attributes on which the classification program works represent, in fact, the events. In accordance with the definition of an event and in accordance with the methodology of extracting the event database, these attributes are not unidimensional, but multidimensional and more than, represent a mixture of categorical and continuous variables. For this reason, the test for selecting the splitting attribute must be a combination of simple tests and accordingly has a number of outcomes equal with the product of the number of outcomes for each simple test on each variable. The disadvantage is that the number of outcomes becomes very high with an increasing number of variables, (which represents the general features). We will give a special attention to this problem by searching specific multidimensional statistical tests that may overcome the relatively high computational costs of the standard approach.

Remark 2. Normally, a special variable such as time will not be considered during the splitting process because its value represents an absolute co-ordinate of an event and does not characterize the inclusion into a class. As we already defined, only a temporal formula contains explicitly the variable time, not the event himself. But another approach, which will be also tested, is to transform all absolute time values of the temporal atoms of a record (from the training set) in relative time values, considering as time origin the smallest time value founded in the record. This transformation permits the use of the time variable as an ordinary variable during the splitting process.

Determining when to stop splitting. There may be two options for controlling when splitting stops:

Minimum n: the spitting process continues until all terminal nodes are pure or contain no more than a specified minimum number of cases or objects (it is the standard criterion chosen by C4.5 algorithm) and

Fraction of objects: the spitting process continues until all terminal nodes are pure or contain no more cases than a specified minimum fraction of the sizes of one or more classes (non feasible because of the absence of apriori information on the size of the classes).

Selecting the “Right-Sized” Tree. Usually we are not looking for a classification tree that classifies perfectly in the learning samples, but one which is expected to predict equally well in the test samples. There may be two strategies that can be adopted to obtain a tree having the “right-size”. One strategy is to grow the tree to just the right size, where the right size is determined by the user from knowledge from previous research, diagnostic information from previous analyses, or even intuition. To obtain diagnostic information to determine the reasonableness of the choice of size for the tree, three options of cross-validation may be used: test sample cross-validation, V-fold cross-validation and global cross-validation. The second strategy involves growing a tree until it classifies (almost) perfect the training set and then pruning at the “right-size”. This approach supposes that it is possible to predict the error rate of a tree and of its subtrees (including leaves). A technique, called minimal cost-complexity pruning and developed by Breiman [BFO84] considers the predicted error rate as the weighted sum of tree complexity and its error on the training cases, with the separate cases used primarily to determine an appropriate weighting. The C4.5 algorithm uses another technique, called pessimistic pruning, that use only the training set from which the tree was built. The predicted error rate in a leaf is estimated as the upper confidence limit for the probability of error (E/N, E-number of errors, N-number of covered training cases) multiplied by N. For our project, the lack of a priori knowledge about the “right size” of the tree, as demanded by the first strategy, makes the approach used by the C4.5 algorithm the better choice for our project.

Before we can start to apply the decision tree algorithms to the event database established in phase one, an important problem may be be solved first: establishing the training set. An n-tuple in the training set contains n−1 values of the predictor variables (or attributes) and one value of the categorical dependent variable, which represent the label of the class. In the first phase we have established a set of events (temporal atoms) where each event may be viewed as a vector of variables, having both discrete and continuous marginal variables. We propose to test two policies regarding the training set.

The first has as principal parameter the time variable. Choosing the time interval t and the origin time t0, we will consider as a tuple of the training set the sequence of events a₍ₜ_{₀}₎, a₍ₜ_{₀}₊₁₎, . . . , a₍ₜ_{₀}₊ₜ₋₁₎ (the first event starts at t₀, the last at t₀+t−1). If the only goal of the final rules would be to predict events then obviously the dependent variable would be the event a₍ₜ_{₀}₊₁₎. But nothing stops us to consider other events as dependent variable (of course, having the same index in the sequence for all tuples in the training set). As observation, to preserve the condition that the dependent variable is categorical, we will consider as label for the class only the name of the event. So, after establishing the time interval t, the origin t₀ and the index of the dependent variable, we will include in the training set all the sequences starting at t₀, t₀+1, . . . , t₀+tₘₐₓ. The parameter tₘₐₓ controls the number of records in the training set. Usually, to benefit the entire quantity of information contained in the time series, t₀ must be fixed at 0 and tₘₐₓ at T−t (where T is the indices of the last value in series). Of course, if the time series is very large, then the training sample may be constructed by randomly sampling from all the possible sequences.

The second has as principal parameter the number of the events per tuple. This policy is useful when we are not interested in all types of events founded during the first phase, but in a selected subset (it's the user decision). Starting at an initial time t₀, we will consider the first n successive events from this restricted set (n being the number of attributes fixed in advance). The choice of the dependent variable, of the initial time t₀, of the number of n-tuples in training set is done in the same way as in the first approach.

Because the training set depends on different parameters, the process of applying the classification tree may comprise creating multiple training sets, by changing the initial parameters. For each set the induced classification tree may be “transformed” into a set of temporal rules. Practically, each path from root to the leaf is expressed as a rule. Of course, the algorithm for extracting the rules is more complicated, because it has to avoid two pitfalls: 1) rules with unacceptably high error rate, 2) duplicated rules. It also uses the Minimum Description Length Principle to provide a basis for offsetting the accuracy of a set of rules against its complexity.

If, despite our efforts to obtain algorithms with “reasonable” time consumption, the amount of time necessary to construct the classification tree which uses the gain ratio criterion will exceed a certain threshold, (because of a large number of variables describing an event or a large number of tuple in the training set), we will test also the QUEST algorithm. The speed advantage of QUEST over an algorithm with exhaustive search for univariate split is particularly dramatic when the predictor variables have dozens of levels [LS97]. The most difficult problem using this algorithm is the adaptation of the split selection algorithm to multidimensional variables.

Next will describe a second inference process. This process is heavily related to the notion of “comprehensibility”.

Comprehensible temporal rules. Especially when the amount of data is very large, the training sets cannot contain all possible events (there are hardware and computational constraints in applying the algorithms). In this case, the multiple training sets, constructed on different time intervals, will lead to different sets of temporal rules. An inference process, using a first-order logic language, will extract new temporal rules from these initial sets. The new temporal rules will present an applicability extended to the entire temporal axis. The comprehensibility of a temporal rule presents two aspects: a quantitative aspect, due to the psychological limits for a human in understanding rules with certain length (and in consequence we will retain temporal rules with a limited number of events) and a qualitative aspect, due to the interestingness of a temporal rule, which can be evaluated only by a domain expert. Of course, there are a variety of metrics which can be used to rank rules [PS91] and these may represent a modality to overcome the necessity of an expert evaluation. We plan to test one metric, the J-measure [SG91], defined (for a rule (B,T+t)←(A,t)) as J(B_{T};A)=p(A)*(p(B_{T}|A)log(P(B_{T}|A)/p(B_{T})+(1−p(B_{T|A))log(}1−p(B_{T}|A)/1−p(B_{T)})) where p(A) is the probability of event A occurring at a random location in the sequence of events, p(B_{T}) is the probability of at least one B occurring in a randomly chosen window of duration T given that the window is immediately preceded by an event A. As shown in [SG91], the J-measure has unique properties as a rule information measure and is in a certain sense a special case of Shannon's mutual information. We will extend this measure to the temporal rules with more than two temporal formulas.

Evaluation Methods

During the unfolding of the project, each phase will be tested and analyzed to ensure that the proposed goals are fulfilled. For this we will use two real-data series coming from two different domains. The first database contains financial time series, representing leading economic indicators. The main type of event experts are searching for are called inflection points. Currently their identification and extraction is made using very complex multidimensional functions. The induced temporal rules we are looking for must express the possible correlation between different economic indicators and the inflection points. The second database originates from the medical domain and represents images of cells during an experimental chemical treatment. The events we are looking for represent forms of certain parts of the cells (axons or nucleus) and the rules must reflect the dependence between these events and the treatment evolution. To allow the analysis of this data in the frame of our project, the images will be transformed in sequential series (the time being given by the implicit order).

Knowing what we must obtain as events and as temporal rules, having the feed-back of the experts from these two domains, we will compare the set of events (obtained after applying the first stage) and the sets of temporal rules (after applying the second stage) with those expected. The results of the evaluation phase will be, of course, concretized into one or two articles intended to be presented during a major conference, in the second year of the project unfolding.

Bibliography

AFS93: R. Agrawal, C. Faloutsos, A. Swami, “Efficient Similarity Search In Sequence Databases”, Proc. Of the Fourth International Conference on Foundations of Data Organisation and Algorithms, pg. 69-84

ALSS95: R. Agrawal, K. Lin, S. Sawhney, K. Shim, “Fast Similarity Search in the Presence of Noise, Scaling, and Translation in Time-Series Databases”, VLDB95, pg. 490-501

APWZ95: R. Agrawal, G. Psaila, E. Wimmers, M. Zait, “Querying Shapes of histories”, VLDB95.

AS95: R. Agrawal, R. Srikant, “Mining sequential patterns”, Proc. Of the International Conference Data Engineering, pg. 3-14, Taipei, 1995

B96: Y. Bengio, Neural Networks for Speech and Sequence Recognition, International Thompson Publishing Inc., 1996

BC94: D. J. Berndt, J. Clifford: “Using dynamic time warping to find patterns in time series”, KDD94, pg. 359-370

BC97: D. J. Berndt, J. Clifford, “Finding Patterns in Time Series: A Dynamic Programming Approach”, Advances in Knowledge Discovery and Data Mining, AAAI Press, 1996.

BFO84: L. Breiman, J. H. Friedman, R. A. Olshen, C. J. Stone,(1984). Classification and regression trees, Monterey, Wadsworth & Brooks/Cole Advanced Books & Software, 1984

BWJ98: C. Bettini, X. Wang, S. Jajodia, “Mining temporal relationship with multiple granularities in time sequences”, Data Engineering Bulletin, 21:32-38, 1998

DGM97: G. Das, D. Gunopulos, H. Mannila, “Finding Similar Time Series”, PKDD97.

DH98: A. Debregeas, G. Hebrail, “Interactive interpretation of Kohonen Maps Applied to Curves”, KDD98.

DLM98: G. Das, K. Lin, H. Mannila, G Renganathan, P Smyth, “Rule Discovery from Time Series”, KDD98.

ES83: B. Erickson, P. Sellers, “Recognition of patterns in genetic sequences”, Time Warps, String Edits and macromolecules: The Theory and Practice of Sequence Comparison, Addison Wesley, MA, 83

FMR98: N. Friedman, K. Murphy, S. Russel, “Learning the structure of dynamic probabilistic networks”, UAI-98, AAAI Press

FJMM97: C. Faloutsos, H. Jagadish, A. Mendelzon, T. Milo, “A Signature Technique for Similarity-Based Queries”, Proc. Of SEQUENCES97, Salerno, IEEE Press, 1997

FRM94: C. Faloutsos, M. Ranganathan, Y. Manolopoulos, “Fast Subsequence Matching in Time-Series Databases”, pg. 419-429

GK95: D. Glodin, C. Kanellakis , “On Similarity Queries for Time-Series Data: Constraint Specification and Implementation,” 1^{st} Conference on the Principles and Practices of Constraint Programming.

HDY99 J. Han, G. Dong, Y. Yin, “Efficient Mining of Partial Periodic Patterns in Time Series Database”, Proc. Of Int. Conf. On Data Engineering (ICDE'99), Sydney, Australia, March 1999, pp. 106-115

HGY98: J. Han, W. Gong, Y. Yin, “Mining Segment-Wise Periodic Patterns in Time-Related Databases”, KDD98.

JB97: H. Jonsson, D. Badal, “Using Signature Files for Querying Time-Series Data”, PKDD97

JMM95: H. Jagadish, A. Mendelzon, T. Milo, “Similarity-Based Queries,” PODS95.

K80: G. V. Kass, “An exploratory technique for investigating large quantities of categorical data”, Applied Statistics, 29, 119-127, 1980.

KP98: E. Keogh, M. J. Pazzani, “An Enhanced Representation of time series which allows fast and accurate classification, clustering and relevance feedback”, KDD98.

KS97: E. Keogh, P. Smyth, “A Probabilistic Approach in Fast Pattern Matching in Time Series Database”, KDD97

LHF98: H. Lu, J. Han, L. Feng, “Stock movement and n-dimensional inter-transaction association rules”, Proc. Of SIGMOD workshop on Research Issues on Data Mining and Knowledge Discovery, pg.12:1-12:7, 1998

LM93: H. Loether, D. McTavish, “Descriptive and Inferential Statistics: An introduction”, 1993.

LS97: W. Loh, Y. Shih, “Split Selection Methods for Classification Trees”, Statistica Sinica, 1997, vol. 7, pp. 815-840

LV88: W. Loh, N. Vanichestakul, “Tree-structured classification via generalized discriminant analysis (with discussion)”. Journal of the American Statistical Association, 1983, pg. 715-728.

M91: R. McConnell, “Ψ-S Correlation and dynamic time warping: Two methods for tracking ice floes in SAR images”, IEEE Transactions on Geoscience and Remote sensing, 29(6): 1004-1012, 1991

M97: S. Mangararis, “Supervised Classification with temporal data”, PhD. Thesis, Computer Science Department, School of Engineering, Vanderbilt University, 1997

MM73: J. Morgan, R. Messenger, “THAID: A sequential analysis program for the analysis of nominal scale dependent variables”, Technical report, Institute of Social Research, University of Michigan, Ann Arbor, 1973

MTV95: H. Manilla, H. Toivonen, A. Verkamo, “Discovering frequent episodes in sequences”, KDD-95, pg. 210-215, 1995

NH97: M. Ng, Z. Huang , “Temporal Data Mining with a Case Study of Astronomical Data Analysis”, Lecture Notes in Computer Science, Springer97 pp. 2-18.

ORS98: B. Ozden, S. Ramaswamy, A. Silberschatz, “Cyclic association rules”, Proc of International Conference on Data Engineering, pg. 412-421, Orlando, 1998

OJC98: T. Oates, D. Jensen, P. Cohen, “Discovering rules for clustering and predicting asynchronous events”, in Danyluk, pg. 73-79, 1998

PS91: G. Piatetsky-Shapiro, “Discovery, analysis and presentation of strong rules”, Knowledge Discovery in Databases, AAAI Press, pg. 229-248, 1991

Q93: J. R. Quinland, “C4.5: Programs for Machine Learning”, Morgan Kauffmann Publishers, San Mateo, Calif., 1993

R96: B. D. Ripley, “Pattern recognition and neural networks”, Cambridge: Cambridge University Press

RJ86: L. Rabiner, B. Juang, “An introduction to Hidden Markov Models”, IEEE Magazine on Accoustics, Speech and Signal Processing, 3, p.4-16, 1986

RM97: D. Rafiei, A. Mendelzon ,“Similarity-Based Queries for Time Series Data,” SIGMOD Int. Conf. On Management of Data, 1997.

S94: P Smyth, “Hidden Markov Models for fault detection in dynamic systems”, Pattern recognition, 27(1), pg. 149-164, 1994

SB99: K. Stoffel, A. Belkoniene, “Parallel k/h means Clustering for Large Data Sets”, EroPar 1999

SC78: H. Sakoe, S. Chiba, “Dynamic programming algorithm optimisation for spoken word recognition”, IEEE Transaction on Acoustics, Speech and Signal Processing, 26, pg. 43-49, 1978

SDS98: K. Stoffel, J. Davis, J. Saltz, G. Rottman, J. Dick, W. Merz, R. Miller, “Query Building Using Multiple Attribute Hierarchies”, Proc. AMIA Annual Fall Symposium

SG91: P. Smith, R. Goodman, “An information theoretic approach to rule induction from databases”, IEEE Transaction on Knowledge and Data Engineering, 4, pg. 301-316, 1991

SH99: K. Stoffel, J. Hendler, “PARKA-DB: Back-End Technology for High Performance Knowledge Representation Systems”, IEEE Expert: Intelligent Systems and Their Applications (to appear)

SR00: K. Stoffel, L. Raileanu, “Selecting Optimal Split Functions for Large Data Sets”, ES2000, Cambridge

SSH97: K. Stoffel, J. Saltz, J. Hendler, R. Miller, J. Dick, W. Merz, “Semantic Indexing for Complex patient Grouping”, Proc. 1997 AMIA Annual Fall Symposium

STH97: K. Stoffel, M. Taylor, J. Hendler, “Efficient management of Very Large Ontologies”, Proc. AAAI-97

SZ96: H.SbatkaY, S. Zdonik , “Approximate Queries and Representations for Large Data Sequences”, ICDE 1996

TSH97: M. Taylor, K. Stoffel, J. Hendler, “Ontology-based Induction of High Level Classification Rules”, SIGMOD Data Mining and Knowledge Discovery Workshop, 1997

THS98: M. Taylor, J. Hendler, J. Saltz, K. Stoffel, “Using Distributed Query Result Caching to Evaluate Queries for Parallel Data Mining Algorithms”, PDPTA 1998

YJF98: B. Yi, H. Jagadish, C. Faloutsos, “Efficient Retrieval of Similar Time Sequences Under Time Warping”, IEEE Proc. of ICDE, 1998

ZR98: G. Zweig, S. Russel, “Speech recognition with dynamic Bayesian networks”, AAI 1998, pg. 173-180

W99: M. Waleed. Kadous, “Learning Comprehensible Descriptions of Multivariate Time Series”, ICML 1999

1. A computer-based data mining method comprising:
a) obtaining sequential raw data;
b) extracting an event database from the sequential raw data; and
c) extracting comprehensible temporal rules using the event database.

2. The method of claim 1, wherein extracting an event database comprises extracting events from a multi-dimensional time series.

3. The method of claim 1, wherein extracting an event database comprises transforming sequential raw data into sequences of events wherein each event is a named sequence of points extracted from the raw data and characterized by a finite set of predefined features.

4. The method of claim 4, wherein extraction of points is obtained by clustering.

5. The method of claim 4, wherein features describing events are extracted using statistical feature extraction processing.

6. The method of claim 1, wherein extracting an event database includes discrete and continuous aspects from the sequential raw data.

7. The method of claim 6, wherein time series discretisation is used to describe the discrete aspect of the sequential raw data.

8. The method of claim 7, wherein the time series discretisation employs a window clustering method.

9. The method of claim 8, wherein the window clustering method includes a window of width w on a sequence s, wherein a set W(s) is formed from all windows w on the set s and wherein a distance for time series of length w is provided to cluster the set W(s), the distance being the distance between normalized sequences.

10. The method of claim 6, wherein global feature calculation is used to describe the continuous aspect of the sequential raw data.

11. The method of claim 1, wherein the sequential raw data is multi-dimensional and more than one time series at a time is considered during the extracting.

12. The method of claim 1, wherein the comprehensible temporal rules have one or more of the following characteristics:
a) containing explicitly at least a sequential and preferably a temporal dimension;
b) capturing the correlation between time series;
c) predicting possible future events including values, shapes or behaviors of sequences in the form of denoted events; and
d) presenting a structure readable and comprehensible by human experts.

13. The method of claim 1, wherein extracting comprehensible temporal rules comprises:
a) utilizing a decision tree procedure to induce a hierarchical classification structure;
b) extracting a first set of rules from the hierarchical classification structure; and
c) filtering and transforming the first set of rules to obtain comprehensible rules for use in feeding a knowledge representation system to answer questions.

14. The method of claim 1, wherein extracting comprehensible temporal rules comprises producing knowledge that can be represented in general Horn clauses.

15. The method of claim 1, wherein extracting comprehensible temporal rules comprises:
a) applying a first inference process, using the event database, to obtain a classification tree; and
b) applying a second inference process using the previously obtained classification tree and the previously extracted event database to obtain a set of temporal rules from which the comprehensible temporal rules are extracted.

16. The method of claim 15, wherein the process to obtain a classification tree comprises:
a) specifying criteria for predictive accuracy;
b) selecting splits;
c) determining when to stop splitting; and
d) selecting the right-sized tree.

17. The method of claim 15, wherein specifying criteria for predictive accuracy includes applying a C4.5 algorithm to minimize observed error rate using equal priors.

18. The method of claim 15, wherein selecting splits is performed on predictor variable used to predict membership of classes of dependent variables for cases or objects involved.

19. The method of claim 15, wherein determining when to stop splitting is selected from one of the following:
a) continuing the splitting process until all terminal nodes are pure or contain no more than a specified number of cases or objects; and
b) continuing the splitting process until all terminal nodes are pure or contain no more cases than a specified minimum fraction of the sizes of one or more classes.

20. The method of claim 15, wherein selecting the right-sized tree includes applying a C4.5 algorithm to a tree-pruning process which uses only the training set from which the tree was built.

21. The method of claim 15, wherein the second inference process uses a first-order logic language to extract temporal rules from initial sets and wherein quantitative and qualitative aspects of the rules are ranked by a J-measure metric.
